(19) United States
(12) Patent Application Publication
(10) Pub. No.: US 2020/0076945 A1
(43) Pub. Date: Mar. 5, 2020

(54) INBOUND CALL TO CHAT

(71) Applicant: CELL BUDDY NETWORK LTD., Tel Aviv (IL)

(72) Inventors: Ofir Paz, Rishon LeZion (IL); Erez Doron, Tel Aviv (IL); Eyal Arbabof, Salit (IL)

(21) Appl. No.: 16/461,602

(22) PCT Filed: Nov. 17, 2017
(86) PCT No.: PCT/IL2017/051257

§ 371 Date: May 16, 2019

Related U.S. Application Data
(60) Provisional application No. 62/423,295, filed on Nov. 17, 2016.

(51) Int. Cl. H04M 3/42; H04L 12/58

(52) U.S. Cl. CPC H04M 3/42382; H04L 51/08; H04M 3/42059

(57) ABSTRACT

A computer-based phone system comprising a computer device comprising: a computer readable memory comprising a set of computer-readable instructions; and a processor operable responsive to the set of computer-readable instructions to: register a caller ID of a caller phone responsive to a phone call received by the computer-based phone system from the caller phone; and transmit via a text communication platform, responsive to registering the caller ID, an invitation to the caller phone to engage in a text communication session.

### RELATED APPLICATIONS

The present application claims benefit under 35 U.S.C. 119(e) of U.S. Provisional Applications 62/423,295 filed on Nov. 17, 2016, the disclosure of which is incorporated herein by reference.

### TECHNICAL FIELD

Embodiments of the disclosure relate to electronic text communication.

### BACKGROUND

Smartphones offer not only phone functionality but also text messaging functionality. SMS (short message service) is available as a default feature on most commercially available smartphones. In addition, a wide variety of additional communication platform applications are typically available for download. Commercial examples of downloadable communication platform applications include WhatsApp®, Skype®, Google Hangouts®, WeChat®, Viber®, Facebook Messenger® and the like. Many communication platforms available for download and use in smartphones are operable to serve as both VoIP (voice over IP) platforms as well as text communication platforms. Once a downloadable communication platform application is loaded onto a smartphone, the communication platform is available for use by the user of the smartphone. As such, a user having a smartphone may have available for use any of the above examples as well as others for use as a text communication platform.

### SUMMARY

An aspect of an embodiment of the disclosure relates to providing a method for initiating an electronic text communication session in response to an incoming phone call. In an embodiment of the disclosure, the method, hereinafter also referred to as a “call-to-chat method”, comprises: (1) registering an identification (“caller ID”) of a phone responsive to a receiving a phone call from the phone; (2) selecting a text communication platform associated with the caller ID; and (3) transmitting to the caller phone via the selected text communication platform an invitation to engage in a text communication session.

For convenience of presentation, a phone initiating the phone call may be referred to herein as a “caller” and the phone receiving the phone call may be referred to herein as a “callee”.

In an embodiment of the disclosure, the caller and/or the callee is a computer-based phone system (the caller or the callee) comprising a computing device comprising or operatively connected to a processor and a display screen, and operable to run a phone application for establishing a two-way simultaneous voice communication session with another phone. Optionally, the computing device is desktop computer, a laptop computer, a tablet computer, a mobile phone or a smartphone. Optionally, the phone application comprises a VoIP application.

In an embodiment of the disclosure, the method further comprises: registering an identification (“callee ID”) of a callee responsive to a phone call made by the caller to the callee; selecting a text communication platform associated with the callee ID and available for use by the callee and the caller; and transmitting via the selected text communication platform an invitation to the callee for the callee to engage in a text communication session with the caller.

In an embodiment of the disclosure, the caller ID is associated with a plurality of text communication platforms that are available for use by the caller, and the method includes selecting one of the plurality of text communication platforms for transmission of the invitation. In an embodiment of the disclosure, the method comprises comparing the plurality of text communication platforms available for use by the caller with a plurality of text communication platforms available for use by the callee, and selecting a text communication platform that is available for use by both the caller and the callee.

In an embodiment of the disclosure, the text communication platform comprises an application loaded onto a smartphone. Alternatively, the text communication platform comprises a web-based text communication platform accessible via a web browser. Optionally, the web-based text communication platform is a microsite. A microsite is typically an individual web page or a small cluster of web pages that are meant to function as a discrete entity within an existing website. In an embodiment of the disclosure, the microsite comprises text communication functionality.

In an embodiment of the disclosure, the invitation comprises a text message sent from the callee to the caller via a text communication platform. Optionally, the invitation comprises a link to a second text communication platform.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1A shows a flowchart illustrating a call-to-text method in accordance with an embodiment of the disclosure;

FIG. 1B shows a flowchart illustrating a procedure for selecting a text communication platform available for use by the caller in accordance with an embodiment of the disclosure;

FIG. 1C shows an alternative call-to-text method in accordance with an embodiment of the disclosure; and

FIGS. 2A-2E schematically shows a sequence of display screens depicting an exemplary operation in a smartphone of a call-to-text method in accordance with an embodiment of the disclosure.

### DETAILED DESCRIPTION

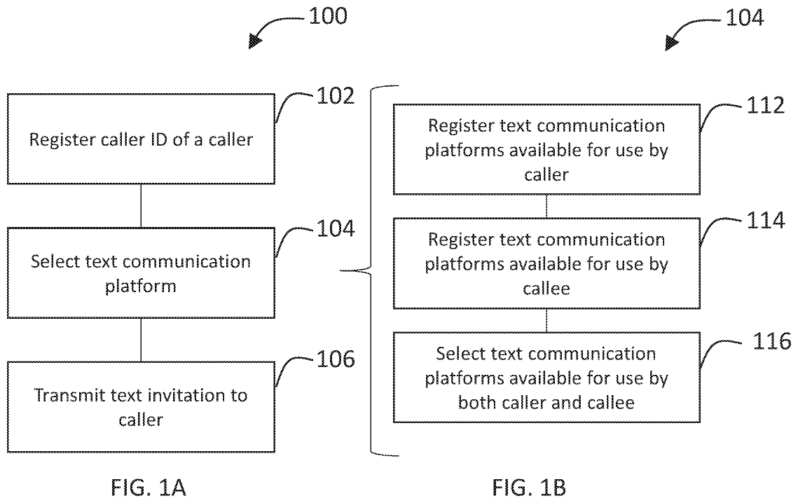

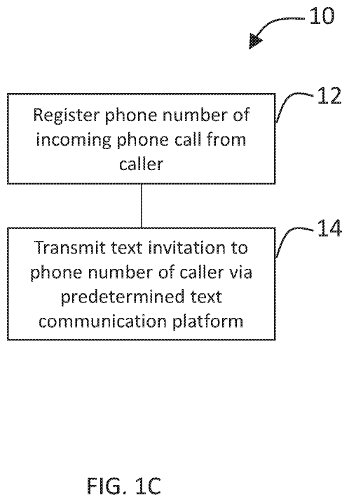

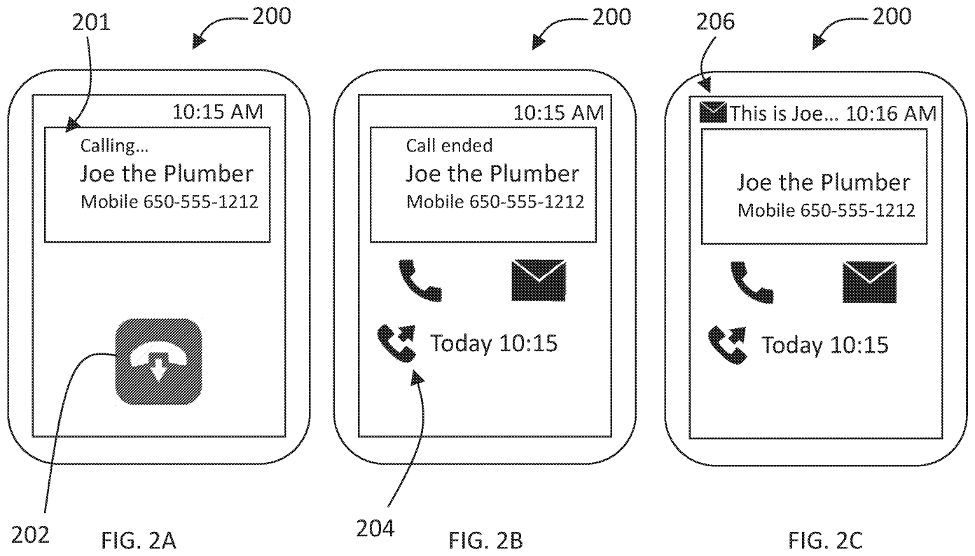

FIG. 1A shows a call-to-text method 100 in accordance with an embodiment of the disclosure. Call-to-text method 100 comprises registering a caller ID of a caller responsive to a receiving a phone call made by the caller to a callee (block 102), selecting a text communication platform associated with the caller ID and available for use by caller (block 104); and transmitting via the selected text communication platform an invitation to the caller, for the caller to engage in a text communication session with the callee (block 106).

Call-to-text method 100 may be performed by a processor optionally comprised inthe callee, responsive to a set of computer executable instructions stored in a computer-readable memory. The computer-readable memory is optionally comprised in or accessible by the callee. Alternatively or in combination, call-to-text method may be performed by a remote computer system or processor accessible to the callee. The remote computer system may optionally comprise a remote server or a remote distributed system, which may be referred to herein as a “cloud computer system.” Optionally, the remote computer system is comprised in a telephony system that is executing the phone call from the caller to the callee.

In an embodiment of the disclosure, where a caller has available for use a plurality of different text communication platforms, at least one text communication platform out of the plurality of text communication platforms is selected for transmitting the invitation. In an embodiment of the disclosure, at least one text communication platform is optionally selected responsive to frequency of use and/or time elapsed since last use, the use being optionally by the caller and/or the callee. By way of example, the text communication platform that has been most frequently used in the past hour, day or week may be selected for sending the invitation.

Reference is made to blocks 102 and 104 shown in FIG. 1A. In an embodiment of the procedure, the caller ID of a given caller, and one or more text communication platforms associated with the caller ID, may be identified based on an electronic contact list, an electronic record comprising names and contact information relating to one or more communication platforms of a plurality of individuals and/or entities. Each individual or entity represented in the contact list may be collectively referred to as a “contact” and characterized by a nickname for easy identification by a user. Each contact in the contact list may be associated with a caller ID and at least one identification (“text ID”) for accessing or identifying the contact in a text communication platform. Where a given contact is registered with a plurality of text communication platforms, the contact may be associated with a plurality of text IDs for each of the plurality of text communications platform, respectively. Some conventional communication platforms are configured to perform both voice and text communication. Thus, in certain embodiments of the disclosure, a caller ID may also serve as a text ID. By way of example, the caller ID may be a phone number assigned to a given contact for use in a PSTN (public switched telephone network) phone system, and the same phone number may also serve as a text ID for a SMS text communication platform. By way of another example, a caller ID may be a username for a voice-over-IP platform, and the same username may serve as a text ID for a web-based or cloud-based text communication (“chat”) platform.

In an embodiment of the disclosure, the contact list (which may be referred to as a “user contact list”) is an electronic record of a plurality of contact names and contact information for people or entities that a phone has communicated with in the past and/or wishes to communicate with in the future. In an embodiment of the disclosure, the contact list (which may be referred to as a “service contact list”) is an electronic record of the plurality of individuals and/or entities that have registered with a common service, optionally an electronic communication platform, optionally a social network service.

The contact list may be saved in a computer-readable memory accessible to the callee. The computer-readable memory may be comprised in the callee or may be located in a remote computer system.

In an embodiment of the disclosure, the selection of the at least one text communication platform may be responsive to the text communication platforms that are available for use by the callee. Optionally, the invitation may be sent to the callee via a text communication platform that is available for use by both the caller and the callee. Reference is now made to FIG. 1B, which shows a flowchart expanding the text communication platform selection of block 104 in accordance with an embodiment of the disclosure, in which the selection process comprises registering text communication platforms available for use by the caller (block 112), registering text communication platforms available for use by the callee (block 114), and selecting a text communication platform available for use by both the caller and the callee (block 116).

Optionally, the text communication platform selected in block 104 may be selected responsive to a combination of the factors provided hereinabove. By way of example the selected text communication platform may be a text communication platform that is available for use by both the caller and callee, and has been frequently used relative to other platforms in the past hour, day or week by the caller and/or the callee.

In an embodiment of the disclosure, call-to-text method 100 further comprises sending to the callee an invitation to engage in a text communication session with the caller, such that an invitation is sent to both the caller and the callee.

In an embodiment of the disclosure, the text communication platform to be used to send the invitation responsive to a phone call is predetermined. By way of example, the predetermined text communication platform is SMS. FIG. 1C shows a call-to-text method 10 in accordance with an embodiment of the disclosure, which comprises registering a phone number of an incoming call from a caller to a callee (block 12) and transmitting, via a predetermined text communication platform, a text message comprising an invitation to the caller for the caller to engage in a text a communication session with the callee (block 14).

Reference is now made to block 106 shown in FIG. 1A. In accordance with an embodiment of the disclosure, the invitation to the caller (or alternatively the caller and the callee) may comprise a text message sent via the text communication platform selected in block 104.

In an embodiment of the disclosure, an invitation is transmitted to the caller responsive to the phone call being unanswered by the callee, optionally without any action being taken by a user of the callee in response to the incoming phone call. Alternatively or additionally, the invitation is transmitted responsive to the phone call being answered by the callee, optionally without any further action being taken by a user of the callee beyond answering the phone call. Optionally, content of the text message comprising the invitation is responsive to whether or not the user of the callee answered the phone call. By way of example, the text message may comprise a message of “Sorry I couldn't take your call” if the phone call was unanswered, or comprise a message of “It was great talking with you” if the user of the callee answered the phone call.

In accordance with an embodiment of the disclosure, the invitation comprises a link to access a second text communication platform. Optionally, the text communication platform selected in block 104 is an SMS platform or a previously downloaded text communication platform application and the second text communication platform is a web-based text communication platform. Optionally, the second text communication platform comprises a downloadable application that is not yet loaded on the caller, and the link comprised in the invitation, when accessed, prompts the user to downloaded the second text communication platform application onto the caller.

In an embodiment of the disclosure, whether or not an invitation is sent, and/or the text content of the invitation may be responsive to one or more following features with respect to the caller: whether or not the caller's contact information is included in a user contact list of the callee; whether or not the caller was sent a messaging invitation from the callee previously; a geographical location of the caller, optionally at the time of the phone call; and a geographical proximity of the caller to the callee. By way of example, the invitation may be transmitted only if the caller's contact information is already included in the callee's contact list. In an embodiment of the disclosure, whether or not an invitation is sent, and/or the text content of the invitation may be responsive to a status the callee at the time of the phone call, including one or more of: power, silent mode, roaming, and battery status. By way of example, an invitation is be transmitted if the callee is on silent mode, but not otherwise, and the invitation optionally states that the phone is on silent mode.

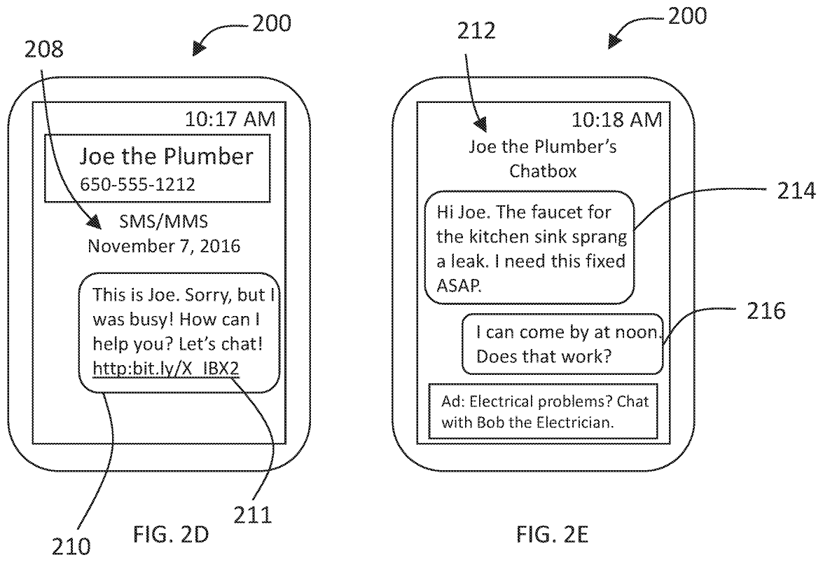

Reference is now made to FIGS. 2A-2E that schematically depict a caller smartphone 200 engaging in a call-to-text method in accordance with an embodiment of the disclosure.

As shown in FIG. 2A, caller smartphone 200 is initiating a phone call to a callee having a contact name “Joe the Plumber” as shown in call information window 201 as per the caller's contact list. The callee does not pick up, and the caller hangs up by pressing a hang-up button 202.

Reference is now made to FIG. 2B. After the caller has hung up, a call log noting the outgoing call made to Joe the Plumber appears.

Reference is now made to FIG. 2C. After the user has hung up, smartphone 200 receives a SMS text message from Joe the Plumber, and a notification 206 for the newly received SMS text message appears at the top of the screen of smartphone 200.

Reference is now made to FIG. 2D. The user opens a SMS function 208 on smartphone 200 to read the new SMS text message invitation 210. The message in invitation 210 is a greeting from Joe the Plumber inviting the user to start a text communication session with him, including a link 211 for accessing a chat function. The text of the greeting may be written by or automatically generated on behalf of the callee.

Reference is now made to FIG. 2E. After the user taps on the link, smartphone 200 opens a web browser to access a microsite 212 comprising a text communication function. Upon microsite 212 being opened, the user may proceed with the text communication session by typing and sending a message 214 to the callee. As shown in FIG. 2E, the user of the callee, Joe the Plumber, responds with a second message 216 to continue with the text communication session.

There is therefore provided in accordance with an embodiment of the disclosure, a computer-based phone system comprising a computer device comprising: a computer readable memory comprising a set of computer-readable instructions; and a processor operable responsive to the set of computer-readable instructions to: register a caller ID of a caller phone responsive to a phone call received by the computer-based phone system from the caller phone; and transmit via a text communication platform, responsive to registering the caller ID, an invitation to the caller phone to engage in a text communication session.

In an embodiment of the disclosure, the text communication platform is selected from a plurality of text communication platforms associated with the caller ID and available for use by the caller phone. Optionally, the selecting of the text communication platform comprises selecting a common text communication platform that is available for use by both the caller phone and the computer-based phone system.

In an embodiment of the disclosure, the text communication platform comprises an application stored on a memory comprised in the computer-based phone system. Alternatively, the text communication platform comprises a web-based text communication platform accessible via a web browser. Optionally, the web-based text communication platform is a microsite.

In an embodiment of the disclosure, the invitation comprises a text message sent to the caller phone via the text communication platform. Optionally, the text message comprises a link to access a second text communication platform. Optionally, the link, when accessed, prompts the caller phone do download the second text communication platform.

In an embodiment of the disclosure, the invitation is transmitted to the caller phone responsive to the phone call being unanswered, without any action being taken by the user of the computer-based phone system in response to the incoming phone call.

In an embodiment of the disclosure, the invitation is transmitted responsive to the phone call being answered, without any further action being taken by the user of the computer-based phone system beyond answering the phone call.

In an embodiment of the disclosure, the the invitation is transmitted responsive to one or more of: whether or not the caller phone's contact information is included in a user contact list of the computer-based phone system; whether or not the caller phone previously received a messaging invitation from the computer-based phone system; and a geographical location of the caller phone.

In an embodiment of the disclosure, the invitation is transmitted responsive to one or more statuses of the computer-based phone system selected from: power, silent mode, roaming, and battery status.

There is further provided in accordance with an embodiment of the disclosure, a computer-based method for establishing an electronic text communication session, the method comprising: registering a caller ID of a caller responsive to a phone call made by the caller to a callee; transmitting via a text communication platform, responsive to registering the caller ID, an invitation to the caller for the caller to engage in a text communication session with the callee, wherein the caller and the callee each comprise a computer-based phone system operable to transmit and receive voice communication and text communication.

In an embodiment of the disclosure, the text communication platform is selected from a plurality of text communication platforms associated with the caller ID and available for use by caller. Optionally, the selecting of the text communication platform comprises selecting a common text communication platform that is available for use by both the caller and the callee.

In an embodiment of the disclosure, text communication platform comprises an application stored on a memory comprised in the caller and/or callee. Alternatively, the text communication platform comprises a web-based text communication platform accessible via a web browser. Optionally, the web-based text communication platform is a microsite.

In an embodiment of the disclosure, the invitation comprises a text message sent to the caller via the text communication platform. Optionally, the text message comprises a link to access a second text communication platform. Optionally, the link, when access, prompts a user of the caller to download the second text communication platform.

In an embodiment of the disclosure, the invitation is transmitted to the caller responsive to the phone call being unanswered by the callee, without any action being taken by a user of the callee in response to the incoming phone call.

In an embodiment of the disclosure, the invitation is transmitted responsive to the phone call being answered by the callee, without any further action being taken by a user of the callee beyond answering the phone call.

In an embodiment of the disclosure, the invitation is transmitted responsive to one or more of: whether or not the caller's contact information is included in a user contact list of the callee; whether or not the caller previously received a messaging invitation from the callee; a geographical location of the caller; and a geographical proximity of the caller to the callee.

In an embodiment of the disclosure, the invitation is transmitted responsive to one or more statuses of the callee selected from: power, silent mode, roaming, and battery status.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

1. A computer-based phone system comprising a computer device comprising:
a computer readable memory comprising a set of computer-readable instructions; and
a processor operable responsive to the set of computer-readable instructions to:
register a caller ID of a caller phone responsive to a phone call received by the computer-based phone system from the caller phone; and
transmit via a first text communication platform, responsive to registering the caller ID, an invitation to the caller phone to engage in a text communication session in a second text communication platform,
wherein the invitation comprises a text message comprising a link to access the second text communication platform.

2. The computer-based phone system in accordance with claim 1, wherein the second text communication platform is selected from a plurality of text communication platforms associated with the caller ID and available for use by the caller phone.

3. The computer-based phone system in accordance with claim 2, wherein the selecting of the second text communication platform comprises selecting a common text communication platform that is available for use by both the caller phone and the computer-based phone system.

4. The computer-based phone system in accordance with claim 1, wherein the second text communication platform comprises an application stored on a memory comprised in the caller's computer-based phone system.

5. The computer-based phone system in accordance with claim 1, wherein the second text communication platform comprises a web-based text communication platform accessible via a web browser.

6. The computer-based phone system in accordance with claim 5, wherein the web-based text communication platform is a microsite.

7-8. (canceled)

9. The computer-based phone system in accordance with claim 1, wherein the link, when accessed, prompts the caller phone to download the second text communication platform.

10. The computer-based phone system in accordance with claim 1, wherein the invitation is transmitted to the caller phone responsive to the phone call being unanswered, without any action being taken by the user of the computer-based phone system in response to the incoming phone call.

11. The computer-based phone system in accordance with claim 1, wherein the invitation is transmitted responsive to the phone call being answered, without any further action being taken by the user of the computer-based phone system beyond answering the phone call.

12. The computer-based phone system in accordance with claim 1, wherein the invitation is transmitted responsive to one or more of: whether or not the caller phone's contact information is included in a user contact list of the computer-based phone system; whether or not the caller phone previously received a messaging invitation from the computer-based phone system; and a geographical location of the caller phone.

13. (canceled)

14. A computer-based method for establishing an electronic text communication session, the method comprising:
registering a caller ID of a caller responsive to a phone call made by the caller to a callee;
transmitting via a first text communication platform, responsive to registering the caller ID, an invitation to the caller for the caller to engage in a text communication session with the callee in a second text communication platform, wherein:
the caller and the callee each comprise a computer-based phone system operable to transmit and receive voice communication and text communication,
the invitation comprises a text message comprising a link to access the second text communication platform.

15. The method in accordance with claim 14, wherein the second text communication platform is selected from a plurality of text communication platforms associated with the caller ID and available for use by caller.

16. The method in accordance with claim 15, wherein the selecting of the second text communication platform comprises selecting a common text communication platform that is available for use by both the caller and the callee.

17. The method in accordance with claim 14, wherein the second text communication platform comprises an application stored on memory of the caller.

18. The method in accordance with claim 14, wherein the second text communication platform comprises a web-based text communication platform accessible via a web browser.

19. The method in accordance with claim 18, wherein the web-based text communication platform is a microsite.

20-21. (canceled)

22. The method in accordance with claim 14, wherein the link, when access, prompts a user of the caller to download the second text communication platform.

23. The method in accordance with claim 14, wherein the invitation is transmitted to the caller responsive to the phone call being unanswered by the callee, without any action being taken by a user of the callee in response to the incoming phone call.

24. The method in accordance with claim 14, wherein the invitation is transmitted responsive to the phone call being answered by the callee, without any further action being taken by a user of the callee beyond answering the phone call.

25. The method in accordance with claim 14, wherein the invitation is transmitted responsive to one or more of: whether or not the caller's contact information is included in a user contact list of the callee; whether or not the caller previously received a messaging invitation from the callee; a geographical location of the caller; and a geographical proximity of the caller to the callee.

26. (canceled)
